(19) United States
(12) Patent Application Publication
(10) Pub. No.: US 2013/0065640 A1
(43) Pub. Date: Mar. 14, 2013

(54) INTELLIGENT PERSONAL COMMUNICATION DEVICE

(71) Applicants: Yuh-shen Song, Northridge, CA (US); Catherine Lew, Northridge, CA (US); Alexander Song, Northridge, CA (US); Victoria Song, Northridge, CA (US)

(72) Inventors: Yuh-shen Song, Northridge, CA (US); Catherine Lew, Northridge, CA (US); Alexander Song, Northridge, CA (US); Victoria Song, Northridge, CA (US)

(21) Appl. No.: 13/673,767

(22) Filed: Nov. 9, 2012

Related U.S. Application Data
(63) Continuation-in-part of application No. 11/335,915, filed on Jan. 18, 2006.

(51) Int. Cl. H04W 88/02

(52) U.S. Cl. 455/556.1

(57) ABSTRACT

An intelligent personal communication device, such as a cellular phone, integrates and interfaces an array of sensors to detect the components in the air so that information regarding the objects or materials that produced the air components can be quickly available to the user of the intelligent personal communication device.

### RELATED APPLICATION

The present application is a continuation in part of U.S. patent application Ser. No. 11/335,915 filed on Jan. 18, 2006, in the names of Y. Song et al., the disclosure of which is expressly incorporated by reference herein in its entirety.

### FIELD

The present disclosure relates generally to the provisioning of intelligent personalized services from a user's cell phone or other portable personal communication device. More specifically, one aspect of the present disclosure uses one or more sensors or wirelessly connected portable devices to detect abnormal and potentially dangerous conditions that could adversely affect the user. In response to the detection of such events, one aspect of the present disclosure determines the position of the device and attempts to initiate or block a communication (e.g., based on a set of predefined rules) with a predetermined party to mitigate any consequent harm to the user.

### BACKGROUND

Patients with adverse health conditions may need emergency care from time to time. Such a patient may lose consciousness when alone at home and cannot call “911” or other help services. In that event, the patient may simply die quietly at home because help services were not requested during the emergency.

Even for a person in normal health, he/she may be unconscious or otherwise unable to handle an adverse condition. For example, a person may be caught in a fire while asleep. A healthy person may also become unconscious as a result of a gas leakage or a terrorist attack involving a toxic gas.

It is also possible that a person is not subject to a true emergency condition but is nevertheless vulnerable. For example, a drunken person may no longer be sufficiently alert to call a relative or friend to pick him/her up from a bar. As a result, the drunken person may eventually fall asleep at the wheel while driving home, thereby exposing the drunken person as well as the public to a great deal of risk.

In the winter of year 2004, a young couple was frozen to death near Omaha, Nebr., USA. Even though they had called “911” for help through their cellular phones, policemen could not identify their exact location. The only information given to the “911” team by the young couple was that they were somewhere near Omaha. When the rescue team eventually found them, it was too late.

The discovery in 1953 that absorption of a gas onto the surface of a metal oxide semiconductor produced a large change in its electrical resistance signaled the advent of semiconductor sensor technology.

In 1962, the first chemo-resistive semiconductor gas sensor was invented for gas detection. Since then, semiconductor gas sensors have been widely used as domestic and industrial gas detectors for gas-leak alarms, fire alarms, process control, pollution control, etc.

The fiscal year 2003 President's budget requested $710 million for the U.S. federal investment in nanoscale science, engineering, and technology, and a majority of the funds were used for applying nanotechnology for chemical-biological-radioactive detection through sensors. Sensors can detect a variety of conditions today.

Personal communication devices, such as cellular phones, personal digital assistants (PDAs), palm computers, wireless phones, satellite phones, smart phones, microwave phones, internet phones, etc. are an integral part of our daily lives. According to statistics published by the telecommunication industry in December 2004, there are more than 130 million cellular phone subscribers in the USA. Most people carry cellular phones with them no matter where they go. A cellular phone provides a ubiquitous means for wide area communication today.

In this document, the terminology “network” or “networks” generally refers to a communication network or networks, which can be wireless or wired, private or public, or a combination of them, and includes the well-known Internet.

In this document, the terminology “cellular phone” can be generally replaced with any portable personal communication device, which operates based on cellular phone network, wireless phone network, satellite communication network, microwave network, the Internet, or any other networks. For easy explanation, we use the terminology “cellular phone” in our examples throughout this document.

### SUMMARY

An aspect of the present disclosure leverages technology to reduce the occurrence of preventable tragedies.

Some configurations provide an early warning to a cellular phone user in the event of an adverse environment, abnormal user health condition, undesirable condition, or an accident.

Other configurations inform predefined third parties that the user entrusts to handle an emergency situation, such that the third parties can locate and arrange for the rescue of the user.

Yet another configuration provides real-time information to a combination of a cellular phone and a portable peripheral device to form a more intelligent system to perform various tasks.

In one configuration, an embedded toxic gas sensor can trigger the cellular phone to produce a sound to alert the user. Moreover, the cellular phone can automatically make an emergency call to one or more designated parties depending on the emergency. The designated party also receives information about the position of the cellular phone, so that a designated responder can find the cellular phone user in a timely manner. Similarly, in case of detecting a fire, a cellular phone can alert the user and automatically make an emergency call to “911” so that the fire department can immediately initiate a rescue mission.

In accordance with another configuration, a gas sensor is integrated with a cellular phone to detect the breath alcohol level of the user, which is then used to control the operation of the cellular phone.

This has outlined, rather broadly, the features and technical advantages of the present disclosure in order that the detailed description that follows may be better understood.

Additional features and advantages of the disclosure are described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

For a more complete understanding of the present disclosure, reference is now made to the following description taken in conjunction with the accompanying drawings.

FIG. 1 illustrates how an intelligent cellular phone can prevent the drunken phone user from making mistakes, and can inform his close friends to locate and send him home according to one aspect of the present disclosure.

FIGS. 2A and 2B are a set of flow charts indicating how the cellular phone shown in FIG. 1 performs this intelligent task according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specifics details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

One aspect of the present disclosure uses a variety of sensors or equivalent devices for different applications. Because different sensors and devices can be used for different purposes, there are many possible configurations and combinations. Accordingly, we will describe some of the preferred configurations and some preferred combinations of the configurations of the present disclosure.

By integrating an array of semiconductor sensors into a cellular phone, the microprocessor of the cellular phone can make intelligent decisions on behalf of a user, that may be unaware of an adverse condition that is detected by the array of sensors.

In one configuration, an array of semiconductor sensors includes gas sensors that can detect toxic gases.

In another configuration, the array of sensors include gas sensors that detect and measure the breath alcohol level of the cellular phone user.

In an alternative configuration, the array of sensors (e.g., within a sensor module) include gas sensors that detect smoke caused by fire or other scents (e.g., smells or odors) caused by different materials in a user environment. The scents are generally caused by some components in the air. The cell phone sends air component information detected from a scent by the sensors to a remote computer system that has a database containing scent identification information associated with different air components. Based on the detected air components, the remote computer system searches the database and identifies the objects or materials (“scent identification information”) that produced the detected air component information. The remote computer system sends the scent identification information for the identified objects or materials back to the cell phone so that the user of the cell phone quickly receives detailed scent identification information describing the objects or materials that produced the scent. For example, when a user uses his cell phone to sense the scent of a particular type of wine, the user receives all information about that particular type of wine from a remote computer system that searches its database to identify a particular type of wine based on the scent of the wine.

In this configuration, an intelligent personal communication device becomes a “virtual nose” for a remote database that provides scent identification information to the cell phone user based on the scent of the components in the air. As technology advances, sensors become more accurate and comprehensive, and databases include more detailed scent identification information. Consequently, an intelligent personal communication device provides all types of information to the user based on the scent or the air components. An alternative solution stores the database locally on the intelligent personal communication device so that the intelligent personal communication device avoids communication with a remote computer system.

In yet another alternative configuration, the cellular phone may communicate through local area wireless technology (e.g., Bluetooth) with a peripheral device when an abnormal health condition (e.g., extremely high blood pressure or irregular heart beat) is detected.

Once the array of sensors detects an adverse condition or the cellular phone has received warning signals from peripheral devices, appropriate actions are taken to protect the user of the cellular phone.

In one configuration, the cellular phone sends an alarm signal to warn the user of the adverse condition, such as the detection of toxic gases.

In another configuration, the cellular phone determines its position and calls some user-predefined third party to inform the third party of the situation and the position of the cellular phone.

Because the position determined by the cellular phone may not have sufficient resolution to locate the cellular phone within a few feet of tolerance, in one aspect of the present disclosure, the cellular phone begins transmitting a distinctive location beacon signal that assists the third parties in easily locating the cellular phone and taking of appropriate action, such as sending the user to a hospital.

There are many known ways to determine the precise position of the cellular phone. For example, because a cellular phone tower, which receives the signal sent by the cellular phone, can determine the distance from and/or direction of the cellular phone, two or more cellular phone towers can use known triangulation techniques to jointly determine the precise location of the cellular phone and inform the cellular phone of its exact position. Alternatively, each cellular phone tower can send the aforementioned distance and direction information to the cellular phone, and the cellular phone can calculate and determine its location by itself. Another possible approach is to include global position circuitry into the cellular phone so that the cellular phone knows its precise position.

When a rescue team gets close to the position of the cellular phone, it can use any precise location information received from the cellular phone or can easily trace any distinctive location beacon signal sent by the cellular phone to precisely locate the cellular phone and rescue the user in time.

When an intoxicated person becomes excited, he/she may be tempted to make phone calls to whoever comes to his/her mind (e.g., a boss, girlfriend, boyfriend, ex-boyfriend, ex-girlfriend, partner, or enemy). Because an intoxicated person typically has little self-control, such a spontaneous phone call may have a very damaging effect on the relationship. Worst of all, most drunken people do not remember what has happened and they do not know how to salvage the situation.

In the event that a high breath alcohol level is detected by the array of sensors, in one aspect of the present disclosure, the cellular phone automatically blocks phone conversations with some user-predefined numbers.

In another aspect of the present disclosure, the cellular phone informs the phone company to begin recording all phone conversations because the user may not remember the conversation when he/she is sober.

In an alternative aspect of the present disclosure, the cellular phone automatically calls and provides the cellular phone position information to user-predefined third parties, which the user entrusts to send the user home when the user is drunk. As an option to the user, the cell phone displays all the nearby hospitals based on the position of the user. The user selects a hospital on the cell phone and the cell phone displays the route path from the user to the selected hospital so that the user can quickly get to his preferred hospital for help. In the above option, the information about each hospital, including its address and position information, is uploaded in advance by the hospital to a remote computer system. The remote computer system stores the information about the hospital, the address, and position information of the hospital in a database. The computer system calculates a distance between the position of the cell phone and the position of the hospital. If the distance is shorter than a predetermined value, the computer system sends the hospital information, the hospital address, and position information to the cell phone.

Hospitals are just used as one example. Any entity (e.g., merchant, business, organization, individual, etc.) can manually or automatically upload its information and position information to the computer system. As a result, the computer system can provide the cell phone user with information of nearby entities and their positions based on the position of the cell phone. Once the user selects a particular entity, the cell phone obtains the information about the entity from the remote computer system and displays the information on the cell phone. The cell phone may also display the route path information from the user (i.e., the cell phone) to the selected entity.

Because the cellular phone can measure the breath alcohol level of the user, it can show the measured result to the user through the cellular phone display so that the user can decide when to stop drinking and when not to drive a car.

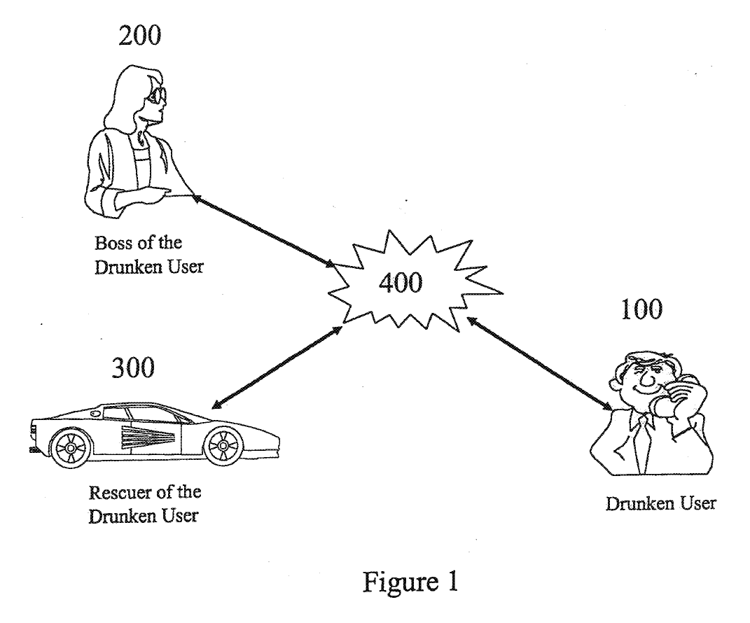

As contemplated in the described inactive aspects, one of the possible combinations of the preferred configurations is given below as an example. As shown in FIG. 1, a drunken cellular phone user 100 becomes excited and begins calling whoever comes to his mind through the cellular phone network 400. The intelligent cellular phone, however, blocks him from any phone conversation with his boss 200, whom the user 100 definitely does not like to talk to when the user 100 is drunk. In addition, a close friend 300 of the user 100 receives a phone call from the intelligent cellular phone, learns about the situation, and tries to locate and send the user 100 back home.

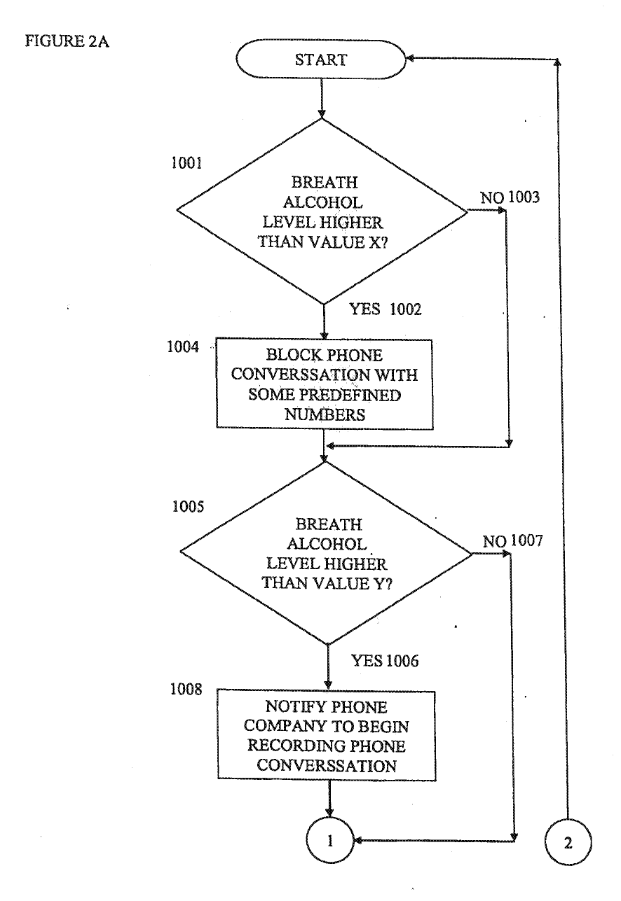

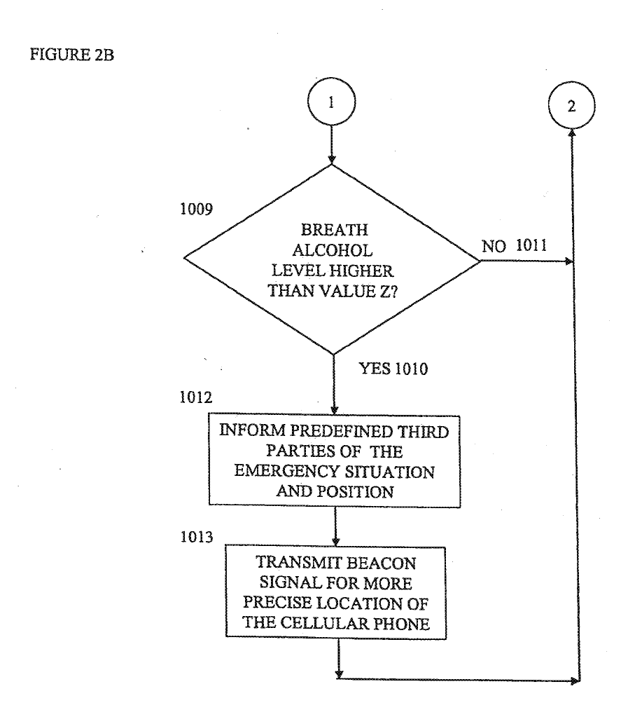

Reference should now be made to the flowchart of FIGS. 2A and 2B in combination with the system diagram of FIG. 1, which together illustrate how the intelligent cellular phone works under such circumstances.

First (decision block 1001), a gas sensor measures the breath alcohol level of the user 100 while making a phone call. In response, a microprocessor of the cellular phone compares the measured result with a user-predefined level X.

If the breath alcohol level is same or lower than X (NO block 1003), no action is taken.

If the breath alcohol level is higher than X (YES block 1002), however, the intelligent cellular phone automatically blocks all phone conversations with some user-predefined numbers (block 1004), which may include the boss 200 of the drunken user 100.

Then (decision block 1005), the gas sensor measures the breath alcohol level of the user 100 and the microprocessor of the cellular phone compares the measured result with a user-predefined level Y.

If the breath alcohol level is same or lower than Y (NO block 1007), no special action is taken.

If the breath alcohol level is higher than Y (YES block 1006), however, the intelligent cellular phone notifies the phone company to begin recording phone conversations (block 1008), which the user 100 may not remember.

To further protect the user (decision block 1009), the gas sensor also measures the breath alcohol level of the user 100, and the microprocessor of the cellular phone compares the measured result with a user predefined level Z.

If the breath alcohol level is same or lower than Z (NO block 1011), no further action is taken.

If the breath alcohol level is higher than Z (YES block 1010), however, the intelligent cellular phone automatically calls and informs some user-predefined close friend 300, whom the user 100 entrusts to handle such kind of situation on behalf of the user 100, in which the situation and the position of the intelligent cellular phone is provided to the user-predefined close friend 300 (Block 1012).

In addition (Block 1013), the intelligent cellular phone transmits a distinctive location beacon signal that may be used by the friend 300 to locate the intelligent cellular phone and the user 100, when he/she arrives at a nearby area.

For easy explanation, we have used the sequence X, Y, Z in the above example. There is no restriction, however, about the relative magnitude or sequence of the numbers X, Y, and Z. Any of these numbers can be larger or smaller than the others.

This example is given to illustrate how an intelligent cellular phone can protect and rescue a drunken user. By using different sensors, an intelligent cellular phone can serve many other purposes, as will be apparent to those skilled in the art.

In one aspect of the present disclosure, with the local area wireless technology such as Bluetooth, a cellular phone can communicate with a portable personal monitor that detects abnormal health conditions of the user and initiates a rescue of the user in the event of emergency.

A person often cannot move easily after a serious accident such as a car crash. A user may not be able to reach for his/her cellular phone, which may be thrown far away from the user due to the accident. If such an event occurs in a rural area during the late evening, the chance the user to get any help is extremely low although timely rescue is extremely important after an accident.

Under such circumstances, a portable personal device, such as a watch, can send a signal to the cellular phone through a local-area wireless technology to make an emergency call and inform predefined parties, which the user entrusts to handle this kind of accident, of the situation and the position of the cellular phone.

At the same time, the cellular phone begins transmitting a distinctive location beacon signal, which the third parties can use to locate the user.

In addition to the life-saving situation as described above, other aspects of the present disclosure provide additional convenience to users. For example, when a user encounters a traffic jam, an intelligent phone of the present disclosure might send a signal to a service organization, which will identify the location of the user and help the user to reroute his driving path to avoid the traffic jam.

Alternatively, an intelligent cellular phone might communicate with the navigation system on the car through Bluetooth wireless technology so that the navigation system can integrate the real-time traffic information provided by a cellular-phone based service organization to find the optimal path for the user to avoid any traffic jam.

In yet another configuration, a patient's body may be monitored by another device to detect a specific emergency condition, such as high blood pressure, etc. When this patient encounters an emergency condition, the monitoring device may automatically transmit a signal to the cellular phone through a local-area wireless technology such as Bluetooth. The cellular phone may then make a phone call to inform a designated third party, for example, a “911” operator, or a paramedic dispatcher, or the emergency room of a hospital, who can immediately initiate a rescue mission based on the position information provided by the intelligent cellular phone, and preferably using a distinctive location beacon signal sent by the cellular phone to locate the person with the emergency condition.

Those skilled in the art will undoubtedly recognize that the described configurations can be assembled in various ways to form a variety of applications based on the need, and that obvious alterations and changes in the described structure may be practiced without meaningfully departing from the principles, spirit and scope of the present disclosure. Accordingly, such alterations and changes should not be construed as substantial deviations from the present disclosure as set forth in the appended claims.

What is claimed is:

1. An intelligent personal communication device, comprising:
a sensor module configured to detect air component information of a scent in a user environment;
a communication module being configured:
to send the air component information to a remote computer system for searching in a database to obtain scent identification information associated with the air component information, and
to receive the scent identification information associated with the air component information; and
a display module for displaying the scent identification information.

2. The intelligent personal communication device of claim 1, in which the scent identification information indicates an object or material that produced the scent.

3. The intelligent personal communication device of claim 1, in which the sensor module comprises an array of semiconductor gas sensors.

4. The intelligent personal communication device of claim 1, in which the intelligent personal communication device comprises a cellular phone, wireless phone, satellite phone, smart phone, and/or microwave phone.

5. A computer system to provide information to a user of a personal communication device, comprising:
a memory device; and
at least one processor coupled to the memory device, the at least one processor being configured:
to receive position information of an entity and entity information from the entity;
to receive position information of the personal communication device from the personal communication device;
to derive a distance between a position of the entity and a position of the personal communication device; and
to send the information about the entity to the personal communication device when the distance is less than a predetermined value.

6. The computer system of claim 5, in which the personal communication device comprises a cellular phone, wireless phone, satellite phone, smart phone, and/or microwave phone.
